(19) United States
(12) Patent Application Publication
(10) Pub. No.: US 2007/0068370 A1
(43) Pub. Date: Mar. 29, 2007

(54) Direct type backlight module

(76) Inventor: Chu-Chi Ting, Hualien City (TW)

Correspondence Address: J.C. Patents, Inc., Suite 250, 4 Venture, Irvine, CA, 92618, US

(21) Appl. No.: 11/245,876

(22) Filed: Oct. 7, 2005

(30) Foreign Application Priority Data
Sep. 19, 2005 (TW) 94132254

(51) Int. Cl. G10H 7/00

(52) U.S. Cl. 84/645

(57) ABSTRACT

A direct type backlight module comprising a frame, a substrate, a plurality of light emitting devices and a light-guiding unit is provided. The frame comprises a base and an enclosing wall extended upward from the edge of the base. The substrate is arranged on the base of the frame, and the light emitting devices are arranged on the substrate. The light-guiding unit covers the light emitting devices and exposes a portion of the substrate, and has a light emitting surface and a light incident surface both of a concave shape. Based on the above mentioned structure, the uniformity of the white light emitted from the direct type backlight module can be improved.

### CROSS-REFERENCE TO RELATED APPLICATION

This application claims the priority benefit of Taiwan application serial no. 94132254, filed on Sep. 19, 2005. All disclosure of the Taiwan application is incorporated herein by reference.

### BACKGROUND OF THE INVENTION

1. Field of the Invention

The present invention generally relates to a backlight module. More particularly, the present invention relates to the direct type backlight module.

2. Description of Related Art

Since the demand of displays is drastically increasing, the industry has devoted full efforts to develop display devices and their associated products. Among these display devices, a cathode ray tube (CRT) had occupied the market for a long time because it had excellent display quality and technology maturity. However, the larger power consumption and the higher radiation features of the CRT contradict to the green environment concept. In addition, to further minimize the occupied space of a CRT is limited. As a result, the CRT can not meet the market trend of a lightweight, thin, short, compact, appealing and low-power consumption product. Accordingly, a thin film transistor liquid crystal display (TFT-LCD) having the features of high image quality, optimal space efficiency and low power consumption has become a mainstream in the market.

The TFT-LCD mainly comprises a liquid crystal display panel and a backlight module. The liquid crystal display panel generally comprises a thin film transistor array substrate, a color filter substrate and a liquid crystal layer sandwiched between them. The backlight module is to providing a surface light source for the liquid crystal display panel, to achieve the display effect. Besides, the backlight module can be divided into two parts: the direct type backlight module and the side type backlight module. Compared with the side type backlight module, the direct type backlight module can provide a surface light source having higher brightness. So, the direct type backlight module is suitable for a display module which requires higher brightness. The description of the details of the direct type backlight module is shown in the following.

FIG. 1 is a schematic cross-sectional view showing a conventional backlight module. The conventional backlight module 100 comprises a frame 110, a heat dissipation plate 120, a plurality of light emitting diode (LED) 130, a diffuser 140 and at least one optical film 150. The heat dissipation plate 120 is arranged inside the frame 110. The LEDs 130 are arranged on the heat dissipation plate 120, so that the heat generated by the LEDs 130 can be conducted to the heat dissipation plate 120. Besides, the LEDs 130 are suitable for emitting red light, green light and blue light respectively. The diffuser 140 is arranged inside the frame 110 and above the LEDs 130. The optical film 150 is arranged on the diffuser 140. Further, the optical film 150 can be a prism sheet.

Red light, green light and blue light emitted from the LEDs 130 are mixed to become white light after traveling through the diffuser 140 and the optical film 150. However, when the brightness of the LEDs 130 is higher, the backlight module can not provide uniform white light if it only has the diffuser 140. In other words, under the condition when the brightness of the LEDs 130 is higher, the uniformity of white light can only be improved by adding the thickness of the diffuser 140 or by using the diffuser 140 with lower transmission rate. Alternately, the uniformity of white light can also be improved by increasing the distance between the LEDs 130 and the diffuser 140, but this doesn't help to minimize the thickness of conventional direct type backlight module 100.

### SUMMARY OF THE INVENTION

Accordingly, the present invention is directed to a direct type backlight module which can provide white light with better uniformity.

The present invention is also directed to providing a direct type backlight module with thinner thickness.

According to an embodiment of the present invention, a direct type backlight module having a frame, a substrate, a plurality of light emitting devices and a light-guiding unit is provided. The frame comprises a base and an enclosing wall extended upward from the edge of the base. The substrate is arranged on the base of the frame, and the light emitting devices are arranged on the substrate. The light-guiding unit covers the light emitting devices and exposes a portion of the substrate. The light-guiding unit comprising a light emitting surface and a light incident surface both of a concave shape.

The above mentioned light-guiding unit may further comprises at least one reflection surface connecting the light emitting surface and the light incident surface.

The above mentioned light-guiding unit is a light guide with a plurality of openings exposing a portion of the substrate. The light guide has the light emitting surface and the light incident surface both of the concave shape and covers the light emitting devices. Besides, the shape of the openings comprises rectangles or stripes.

The above mentioned light-guiding unit comprises a plurality of pillar shape light guides separated from each other, the pillar shape light guides are arranged on the substrate and expose a portion of the substrate. Each pillar shape light guide has the light emitting surface and the light incident surface both of the concave shape and covers at least one of the light emitting devices.

The direct type backlight module may further comprise a diffuser arranged on the light-guiding unit.

According to another embodiment of the present invention, a direct type backlight module having a frame, a substrate, a plurality of light emitting devices and a plurality of light guides is provided. The frame comprises a base and an enclosing wall extended upward from the edge of the base, and the substrate is arranged on the base of the frame. The light guides are arranged on the substrate and each light guide has a light incident surface facing the enclosing wall and a light emitting surface facing upward. These light emitting devices are arranged on the substrate and next to the light incident surfaces of the light guides.

Each mentioned light guide comprises a plate attached to the substrate and a protrusion part extended outward and upward from one side of the plate, the light incident surface is disposed at the other side of the plate, and the light emitting surface is disposed at a top surface of the protrusion part.

The light incident surface of each mentioned light guide is a concave.

The light emitting surface of each mentioned light guide is a concave.

Each mentioned light guide further comprises at least one reflection surface connecting the light emitting surface and the light incident surface.

The direct type backlight module may further comprise a diffuser arranged on the light guides.

In summary, the direct type backlight module of the invention utilizes different types of light-guiding unit or light guides, so that the light with different colors emitted from the light emitting devices may be mixed inside the light-guiding unit or light guides, to improve the uniformity of the white light.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view according to a conventional direct type backlight module.

FIGS. 2A and 2B are perspective views showing a light-guiding unit according to the first embodiment of the present invention respectively.

FIG. 2C is a cross sectional view showing a direct type backlight module according to the first embodiment of the present invention.

FIGS. 3A and 3B are perspective views showing a light-guiding unit according to the second embodiment of the present invention.

FIG. 4A is a perspective view showing a light guide of the direct type backlight module according to the third embodiment of the present invention.

FIG. 4B is a cross-sectional view showing a light guide of the direct type backlight module according to the third embodiment of the present invention.

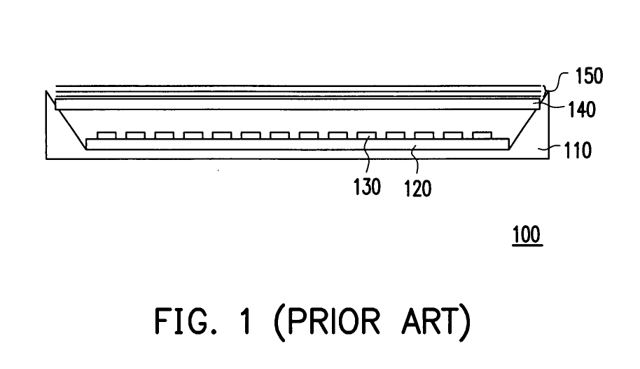

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### First Embodiment

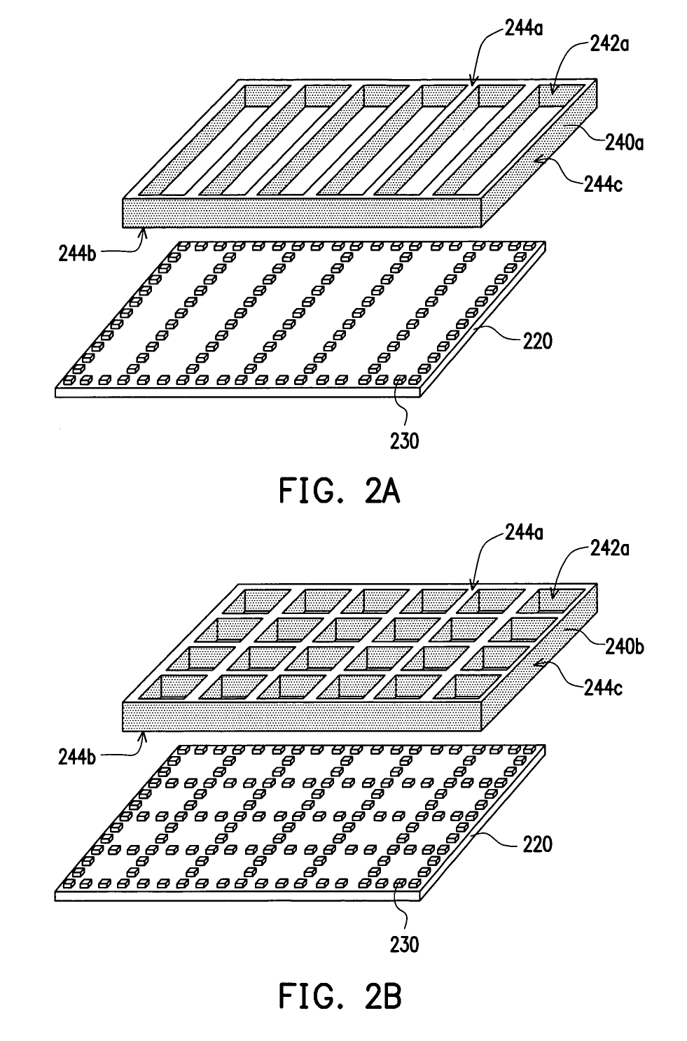

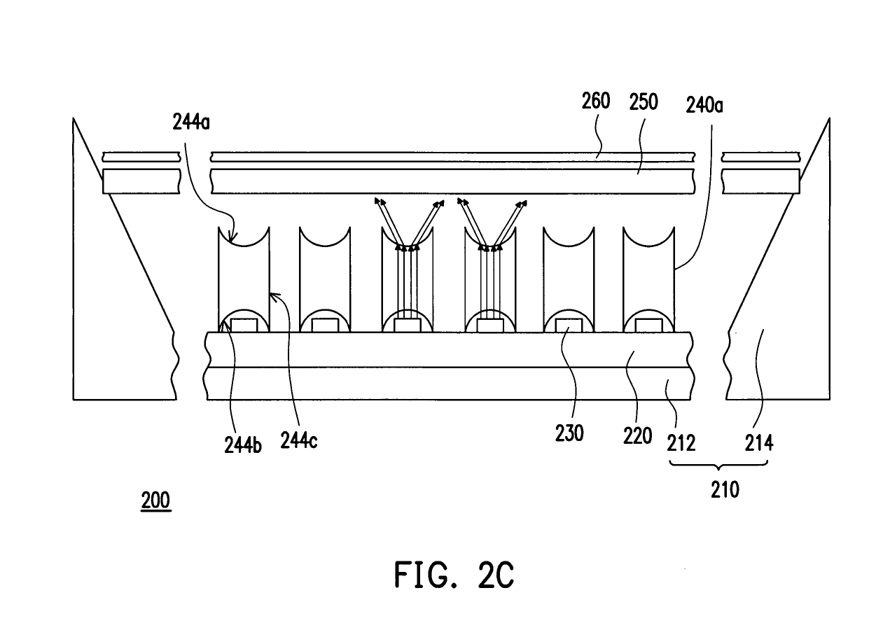

FIGS. 2A and 2B are perspective views showing a light-guiding unit according to the first embodiment of the present invention respectively. FIG. 2C is a cross sectional view showing a direct type backlight module according to the first embodiment of the present invention. Please refer to FIGS. 2A and 2C, the direct type backlight module 200 of the present invention comprises a frame 210, a substrate 220, a plurality of light emitting devices 230 and a light-guiding unit 240a is provided. The frame 210 comprises a base 212 and an enclosing wall 214 extended upward from the edge of the base 212. The substrate 220 is arranged on the base 212 of the frame 210. Besides, the material of the frame 210 can be metal or plastic and the material of the substrate 220 can be metal, ceramic, glass, silicon substrate or other suitable material. When the material of the substrate 220 is metal, it can also be regarded as a heat dissipation plate.

These light emitting devices 230 are arranged on the substrate 210, and they can be light emitting diodes (LED), organic electro-luminescent diodes (OLED) or other types of light emitting devices. These light emitting devices 230 emit blue light, red light and green light respectively. Alternatively, these light emitting devices 230 emit blue light and yellow-green light to generate white light after the light is mixed. However, other methods which generate white light after the light is mixed can also apply to the embodiment. Besides, these light emitting devices 230 can be chip types or package types. Further, each light emitting device 230 emitting light with different colors can be arranged together or individually.

The light-guiding unit 240a covers the light emitting devices 230 and exposes a portion of the substrate 220. That is to say, the light-guiding unit 240a is arranged inside the frame 210 and above the light emitting devices 230. In this embodiment, the light-guiding unit 240a is a light guide with a plurality of openings 242a for example. The openings 242a expose a portion of the substrate 210 between the light emitting devices 230. Besides, the shapes of the openings 242a should match the arrangement of these light emitting devices 230. In this embodiment, the shapes of the openings 242a are stripes, but they can also be rectangles (as shown in FIG. 2B), circles or other shapes.

More specifically, the light-guiding unit 240a comprises a light emitting surface 244a and a light incident surface 244b. The light emitted from each light emitting device 230 is incident into the corresponding light incident surface 244b and exits the light-guiding unit 240a from the light emitting surface 244a. These light emitting surface 244a and light incident surface 244b are concaves for enhancing the light mixing effect. However, each light emitting surface 244a or light incident surface 244b can also be a plate, concave or other shapes. Because the light emitted from these light emitting devices 230 are mixed inside the light-guiding unit 240a, when these light emitting devices 230 can provide the light with higher brightness (more than 5 KW), the uniformity of the white light generated by this direct type backlight module 200 can be improved.

In this embodiment, the direct type backlight module 200 further comprises a diffuser 250 to improve the optical quality. The diffuser 250 is fixed on the frame 210 and arranged above the light-guiding unit 240a. Besides, the direct type backlight module 200 may also comprise at least one optical film 260. The optical film 260 is fixed on the frame 210 and arranged above the diffuser 250. Further, the optical film 260 may be a prism sheet or a dual brightness enhanced film (DBEF).

The light-guiding unit 240a may comprise at least one reflection surface 244c in order to enhance the light mixing effect. Each reflection surface 244c is connected to the corresponding light emitting surface 244a and light incident surface 244b. For example, a metal layer is formed on the sidewall (inner sidewall and outer sidewall) of the light-guiding unit 240a to form a plurality of reflection surfaces 244c. The reflection surfaces 244c can be fabricated by sputtering or attaching a reflection layer on the sidewall of the light-guiding unit 240a. The material of the reflection layer is metal or white polymer.

In this embodiment, the contours of the light emitting surface 244a and light incident surface 244b are the same as those of the concave lenses, to improve the light mixing effect. However, the shapes of the light emitting surface 244a and light incident surface 244b can also be a plane or other types.

Please refer to FIG. 2B, these light emitting devices 230 can also be arranged as a grid array on the substrate 210 for example. Besides, the light-guiding unit 240a comprises a plurality of openings 242a, and the shapes of the openings 242a are rectangulars. Similarly, the light-guiding unit 240a may also comprise a plurality of light emitting surfaces 244a, a plurality of light incident surfaces 244b and a plurality of reflection surfaces 244c. Each reflection surface 244c is connected to the light emitting surface 244a and light incident surface 244b. Besides, the shapes of the light emitting surface 244a and light incident surface 244b can be planes, similar to the contour of the concave lens (as shown in FIG. 2C) or other types.

### Second Embodiment

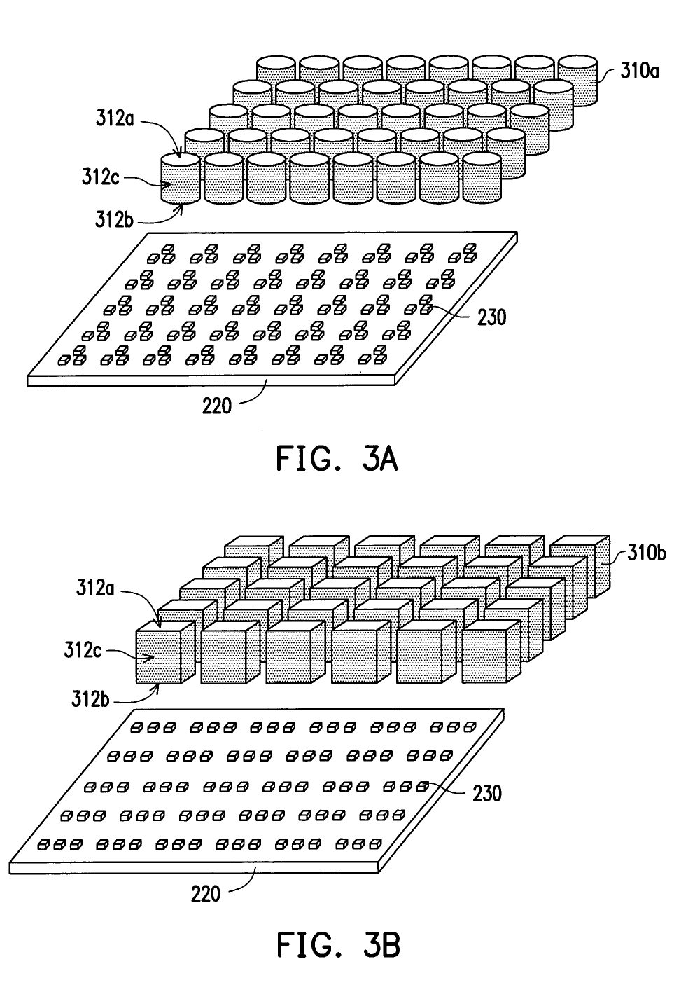

FIGS. 3A and 3B are perspective views showing a light-guiding unit of the direct type backlight module according to the second embodiment of the present invention. Please refer to FIGS. 3A and 3B, the second embodiment is similar to the first embodiment, but the difference between them is that the light-guiding unit is a plurality of pillar shape light guides separated from each other. These pillar shape light guides 310a and 310b are arranged on these light emitting devices 230. The pillar shape light guides 310a are cylinders (as shown in FIG. 3A), and the pillar shape light guides 310b are quadrangular prisms. Each pillar shape light guide 310a has a light emitting surface 312a and a light incident surface 312b, and the light emitted from the light emitting device 230 would be mixed inside the pillar shape light guides 310a in order to generate uniform white light. Similarly, the shapes of the light emitting surface 312a and light incident surface 312b can be planes, similar to the contour of the concave lens (as shown in FIG. 2A) or other types.

Besides, each pillar shape light guide 310a may also have a reflection surface 312c to enhance the light mixing effect, and the reflection surface 312c is connected to the light emitting surface 312a and the light incident surface 312b. But for pillar shape light guides 310b, the pillar shape light guides 310b have a plurality of reflection surfaces 312c, and each reflection surface 312c is connected to the light emitting surface 312a and the light incident surface 312b. In this embodiment, the height of the pillar shape light guides 310a and 310b is between 1 cm and 2 cm. In addition, the pillar shape light guides 310b may be trigonal prisms, pentagonal prisms or other polyhedral prisms. However, the pillar shape light guides 310a and 310b can also be irregular prisms.

It should be noted that if the light emitting devices 230 of the embodiment comprises red light, blue light and green light emitting devices, then each pillar shape light guides 310a and 310b should be at least corresponding to a red light emitting device, a blue light emitting device and a green light emitting device, such that the red light, the blue light and the green light are mixed inside the pillar shape light guides 310a and 310b to generate white light. In other words, if the white light is generated by different mixing method (like blue light and yellow-green light), each pillar shape light guide 310a and 310b is corresponding to different light emitting devices 230. Besides, the arrangement of the light emitting devices 230 is not limited to what is shown in FIGS. 3A and 3B, they can be arranged in other manner.

### Third Embodiment

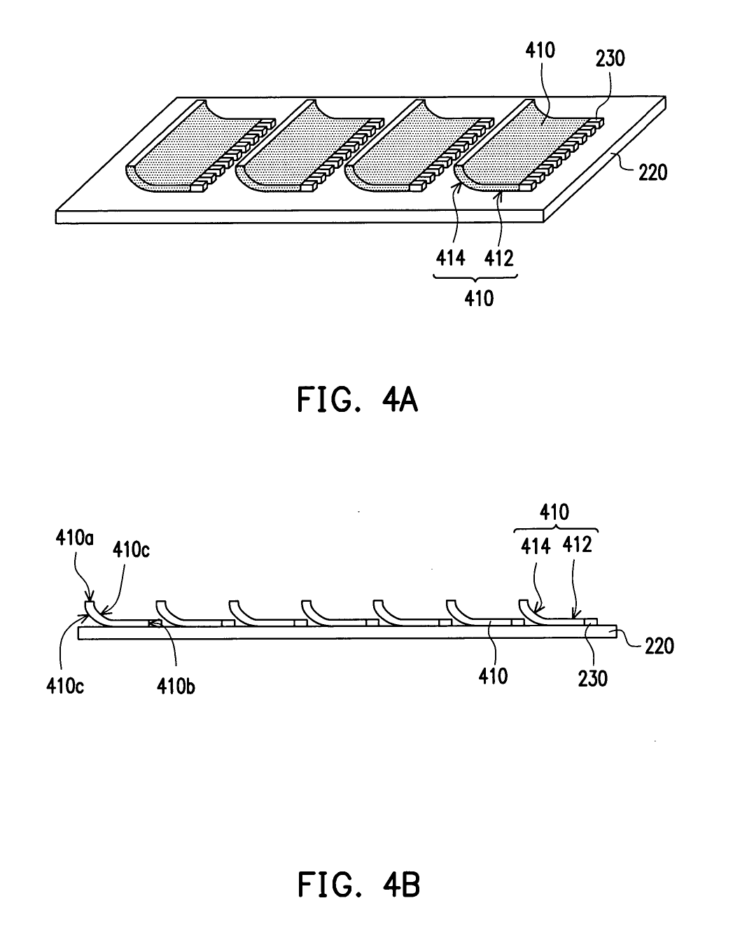

FIG. 4A is a perspective view showing a light guide of the direct type backlight module according to the third embodiment of the present invention and FIG. 4B is a cross-sectional view showing a light guide of the direct type backlight module according to the third embodiment of the present invention. Please refer to FIGS. 4A and 4B, this embodiment is similar to the above mentioned embodiments, the difference is that these light guides 410 are arranged on the substrate 220, each light guide 410 comprises a plate 412 attached to the substrate 220 and a protrusion part 414 extended outward and upward from one side of the plate 412. Each light guide 410 has a light emitting surface 410a and a light incident surface 410b, the light incident surface 410b is disposed at the other side of the plate 412, and the light emitting surface 410a is disposed at a top surface of the protrusion part 414. These light emitting devices 230 are arranged at the side of the light incident surfaces 410b of the corresponding light guides 410 respectively. In other words, the light guide 410 is a side incident type. In addition, these light emitting surface 410a and light incident surface 410b can be planes, similar to the contour of the concave lens (as shown in FIG. 2C) or other types.

It should be noted that the distance between the light emitting surface 410a and the substrate 220 is larger than the thickness of the light-guiding plate 410 in this embodiment. In other words, one end of the light-guiding plate tilts upward. However, the distance between the light emitting surface 410a and the substrate 220 can also be the same as the thickness of the light guides 410. At this time, the light guide 410 is a plane, and this would make the direct type backlight module become thinner.

In summary, the direct type backlight module of the invention has the following advantages:

1. The light with different colors emitted from the high brightness light emitting devices can be mixed inside every kind of the light-guiding unit or light guides in advance, to improve the uniformity of white light.

2. Because the light emitted from the light emitting devices can be mixed inside every kind of the light-guiding unit or light guides, the whole thickness of the direct type backlight module can be thinner.

It will be apparent to those skilled in the art that various modifications and variations may be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A direct type backlight module, comprising:
a frame comprising a base and an enclosing wall extended upward from the edge of the base;
a substrate arranged on the base of the frame;
a plurality of light emitting devices arranged on the substrate; and
a light-guiding unit covering the light emitting devices and exposing a portion of the substrate, wherein the light-guiding unit has a light emitting surface and a light incident surface both of a concave shape.

2. The direct type backlight module according to claim 1, wherein the light-guiding unit further comprises at least one reflection surface connecting the light emitting surface and the light incident surface.

3. The direct type backlight module according to claim 1, wherein the light-guiding unit is a light guide with a plurality of openings exposing a portion of the substrate, the light guide has the light emitting surface and the light incident surface both of the concave shape and covers the light emitting devices.

4. The direct type backlight module according to claim 3, wherein the shape of the openings comprises rectangles.

5. The direct type backlight module according to claim 3, wherein the shapes of the openings comprises stripes.

6. The direct type backlight module according to claim 1, wherein the light-guiding unit comprises a plurality of pillar shape light guides separated from each other, the pillar shape light guides are arranged on the substrate and expose a portion of the substrate, each pillar shape light guide has the light emitting surface and the light incident surface both of the concave shape and covers at least one of the light emitting devices.

7. The direct type backlight module according to claim 1, further comprising a diffuser arranged on the light-guiding unit.

8. A direct type backlight module, comprising:
a frame comprising a base and an enclosing wall extended upward from the edge of the base;
a substrate arranged on the base of the frame;
a plurality of light guides arranged on the substrate wherein each light guide comprises a light incident surface facing the enclosing wall and a light emitting surface facing upward; and
a plurality of light emitting devices arranged on the substrate and next to the light incident surfaces of the light guides.

9. The direct type backlight module according to claim 8, wherein each light guide comprises a plate attached to the substrate and a protrusion part extended outward and upward from one side of the plate, the light incident surface is disposed at the other side of the plate, and the light emitting surface is disposed at a top surface of the protrusion part.

10. The direct type backlight module according to claim 8, wherein the light incident surface of each light guide is a concave.

11. The direct type backlight module according to claim 8, wherein the light emitting surface of each light guide is a concave.

12. The direct type backlight module according to claim 8, wherein each light guide further comprises at least one reflection surface connecting the light emitting surface and the light incident surface.

13. The direct type backlight module according to claim 8, further comprising a diffuser arranged on the light guides.
